(19) United States
(12) Patent Application Publication
(10) Pub. No.: US 2023/0348768 A1
(43) Pub. Date: Nov. 2, 2023

(54) ADHESIVE COMPOSITION

(71) Applicant: Quin Global US, Inc., Omaha, NE (US)

(72) Inventors: Matthew Petersen, Omaha, NE (US); Matt Benson, Omaha, NE (US); Andre Mayer, Paris (FR)

(21) Appl. No.: 18/141,847

(22) Filed: May 1, 2023

Related U.S. Application Data
(60) Provisional application No. 63/336,508, filed on Apr. 29, 2022.

(51) Int. Cl. C09J 183/04

(52) U.S. Cl. CPC C09J 183/04

(57) ABSTRACT

The present disclosure is an adhesive composition which is compatible with propellants, suitable for deployment via a canister, and configured for use on substrates which include rubber such as thermoplastic polyolefin (TPO) and plastic such as polyvinyl chloride (PVC). In one embodiment of the present disclosure, the adhesive composition may include a polymer, the polymer is a blend of a silylated polymer with silicone resin intermediate and a tackifying resin, the tackifying resin includes gum rosin, wherein the adhesive composition has a peel strength of a 180-degree peel of at least 5 pounds per linear inch (PLI) on each of rubber and plastic.

### CROSS-REFERENCE TO RELATED APPLICATIONS

The present application claims the benefit under 35 U.S.C. § 119(e) of U.S. Provisional Application Ser. No. 63/336,508, filed Apr. 29, 2022. The U.S. Provisional Application Ser. No. 63/336,508, filed Apr. 29, 2022, is incorporated herein by reference in its entirety.

### TECHNICAL FIELD

The present disclosure generally relates to adhesive compositions, and more particularly to an adhesive composition, compatible with propellants, suitable for deployment via a canister, and configured for use on substrates which include rubber such as thermoplastic polyolefin (TPO) and plastic such as polyvinyl chloride (PVC).

### BACKGROUND

Adhesives are employed in various applications. One type of application is the application of an adhesive to bond a rubber membrane to a roof, particularly, a flat or low-slope roof. Conventional adhesives fail to provide an adequate peel strength. Furthermore, conventional adhesives are difficult to spray effectively, and application of adhesives via brush or roller are wasteful and problematic.

### SUMMARY

Accordingly, the present disclosure is directed to an adhesive composition which is compatible with propellants, suitable for deployment via a canister, and configured for use on substrates which include rubber such as thermoplastic polyolefin (TPO) and plastic such as polyvinyl chloride (PVC). In one embodiment of the present disclosure, the adhesive composition may include a polymer, the polymer may be a blend of a silylated polymer with silicone resin intermediate, and a tackifying resin, the tackifying resin includes gum rosin, wherein the adhesive composition has a peel strength of a 180-degree peel of at least 5 pounds per linear inch (PLI) on each of rubber and plastic.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

Embodiments are described more fully below with reference to the accompanying FIGURES, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The present disclosure is directed to an adhesive composition which is compatible with propellants, suitable for deployment via a canister, and configured for use on substrates which include rubber such as thermoplastic polyolefin (TPO) and plastic such as polyvinyl chloride (PVC). In one embodiment of the present disclosure, the adhesive composition may include a polymer, the polymer is a blend of a silylated polymer with silicone resin intermediate, and a tackifying resin, the tackifying resin includes a gum rosin, wherein the adhesive composition has a peel strength of a 180-degree peel of at least 5 pounds per linear inch (PLI) on each of PVC and TPO.

The adhesive composition of the present disclosure may be configured to bond thermoplastic, rubber membrane, foam, polymeric plate, or glass fibers mesh to substrates like wood, concrete, or metal. The adhesive composition may be useful for adhering thermoplastic, rubber membrane, foam, polymeric plat or glass fibers mesh with high peel resistance above 5 PLI (pounds per linear inch), whereby 5 PLI may be above the minimum peel resistance required in many industrial or construction applications. It is contemplated that the adhesive composition may be applied on one or on both sides of the surfaces to be bonded. The surfaces to be bonded may be joined after 5 to 15 minutes while the adhesive composition may be still liquid (leggy or tacky).

A number of experiments have been performed that include various combinations of polymers, the polymers including a blend of silylated polymer and silicone resin intermediate, tackifying resins, platicizers, catalysts, dessicants, and fillers.

It is contemplated that a silylated polymer, also referred as a silyl-modified polymer, may be polymers that terminate with a silyl group. It is contemplated that the adhesive composition may include two ends terminated polymer or a blend of two ends with a mono-functional one end terminated polymer, and may be represented by the following formula:

(P(−R−SiXYZ))n Formula 1

P may be a divalent bonding polymer radical containing at least one heteroatom, R may be selected from divalent hydrocarbon residues having 1 to 6 carbon atoms, preferably 1 to 3 carbon atoms, and more preferably 1, X, Y, Z are independent of one another, selected from the group consisting of a hydroxyl group and C1 to C3 alkyl, C1 to C 3 alkoxy, wherein X, Y, Z are substituents directly bound with the Si atom or the two of the substituents X, Y, Z form a ring together with the Si atom to which they are bound, and at least one of the substituents X, Y, Z is selected from the group consisting of a hydroxyl group C1 to C3 alkoxy, or C1 to C3 acyloxy groups, and n is an integer from 1 to 6, or more preferably 2.

Polymer radical P preferably comprises organic polymer radicals which as a polymer chain comprise polyoxyalkylenes such as polyoxyethylene, polyoxypropylene, polyoxybutylene, polyoxytetramethylene, polyoxyethylene-polyoxypropylene copolymer, and polyoxypropylene polyoxybutylene copolymer or copolymers of polyurethanes; polyesters, polyamides; poly(metha)acrylates; and polycarbonates, and which are bonded preferably via one heteroatom (nitrogen, oxygen, sulfur) to the group or groups—SiXYZ.

It is contemplated that the polymer of the adhesive composition may include a silicone resin intermediate. A silicon resin intermediate may be a type of silicone material formed by branched, cage-like oligosilizanes. It is contemplated that the silicone resin intermediate may be of the general formula 2 as shown below:

R³_{c}(R⁴O)_{d}R⁵ₑSiO_{(4-c-d-e)/2} Formula 2

R3 may be identical or different and may be hydrogen, a monovalent, SiC-bonded, optionally substituted aliphatic hydrocarbon radical, or a divalent, optionally substituted, aliphatic hydrocarbon radical which bridges two units of the Formula 2 where c is 0, 1, 2, or 3. R4 may be identical or different and may be hydrogen or a monovalent, optionally substituted hydrocarbon radical where d is 0, 1, 2, or 3, preferably 0, 1, or 2, more preferably 0 or 1. R5 may be identical or different and may be a monovalent, SiC bonded, optionally substituted aromatic hydrocarbon radical where e is 0, 1, or 2, preferably 0 or 1. It is contemplated that the Sum of c-d-e is less than or equal to 3 and in at least 40% of the units of the Formula 2, the sum c+e is 0 or 1.

The combination of a silylated polymer and a silicone resin intermediate for an adhesive, without an added tackifying resin as disclosed in the present application, may not have adequate peel strength for commercial applications. For example, the combination of a silylated polymer and a silicone resin intermediate for an adhesive, without an added tackifying resin as disclosed in the present application, may not have the peel strength of a 180-degree peel of at least 5 pounds per linear inch (PLI) on each of rubber and plastic. It should be understood that rubber, such as thermoplastic polyolefin (TPO), may have low surface energy and plastic, such as polyvinyl chloride (PVC), may have high surface energy. It is desirable that an adhesive composition may have a high peel strength the peel strength of a 180-degree peel of at least 5 pounds per linear inch (PLI) on rubber and plastic.

In one embodiment, the adhesive composition of the present disclosure may include a polymer with a blend of silylated polymer and a silicone resin intermediate, and a tackifying resin. The addition of the tackifying resin may provide the adhesive composition with a 180-degree peel of at least 5 pounds per linear inch (PLI) on rubber and plastic.

A tackifying resin, also known as a tackifier, may refer to low-molecular weight compounds (oligomers) that are added to adhesive compositions to improve tack and peel adhesion. Tackifying resins may have a glass transition temperature (Tg) is typically higher than that of the base polymer but their molecular weight is much lower. The tackifying resin of the present disclosure may include gum rosin, and may further include coumarone indene or a terpene phenol. Gum rosin may refer to thermoplastic resins based on gum rosins and modified gum rosin derivatives. Coumarone indene may refer to a thermoplastic resin obtained by polymerization of mixtures of coumarone and indene. A terpene phenol may refer to resin obtained by copolymerization of terpene monomer and phenol.

It is contemplated that the tackifying resin may be gum rosin, the tackifying resin may be a blend of gum rosin and coumarone indene, and the tackifying resin may be a blend of gum rosin and terpene phenol. In another embodiment, tackifying resin may be a blend of gum rosin, coumarone indene, and terpene phenol.

It is contemplated that the adhesive composition may include additional ingredients in addition to the components already disclosed, which may contribute to the expression of desired properties. Thus, it may be desirable to add one or more plasticizers to adjust the properties and processability of the composition, one or more fillers, and one or more stabilizers such as anti UV and antioxidant. For example, the adhesive composition may further include at least one plasticizer, at least one catalyst, and optional adhesion promotor and moisture scavenger.

Based on the experimental data, exemplary silylated polymers may include the following:

| Polymer | |
|---|---|
| Wacker XT 50 | High strength alpha silylated |
| | polymer #1-silicone resin modified |
| Wacker XT 55 | High strength gama-silylated |
| | polymer #2-silicone resin modified |
| Wacker STPE 35 | Silyl terminated polymer #1 |
| Wacker STPE 30 | Silyl terminated polymer #2 |
| Wacker STPE 10 | Silyl terminated polymer #3 |
| Wacker STPE 15 | Silyl terminated polymer #4 |
| Wacker XM25 | reactive diluent #1 |
| Wacker XM20 | reactive diluent #2 |
| Kaneka S400 | Branched Dimethoxysilyl Polymer |
| Kaneka SAT145 | Linear mono function |
| | dimethoxysilyl reactive diluent |
| Kaneka SAX 590 | High strength Branched |
| | Trimethoxysilyl Polymer |
| Kaneka SAX 530 | High strength Linear |
| | Trimethoxysilyl Polymer |
| Kaneka MA850 | Acrylic modified-silylated polymer |
| Kaneka sat 010 | Linear dimethoxysilyl reactive diluent |
| Evonik polymer ST80 | High strength Silylated polyurethane |
| Evonik Polymer ST81 | High strength Silylated polyurethane |
| RISUN 30000T | Trimethoxy silane terminated |
| | polyether polymer |

The exemplary silylated polymers, namely, WACKER XT 50 and WACKER XT 55, include a silylated polymer and a silicone resin intermediate. The other exemplary silylated polymers included in the previous list may not include a silicone resin intermediate, but a silicone resin intermediate could be added to the silylated polymer.

Based on the experimental data, silicon resin intermediate may include Silikophen AC 900 by Evonik, Silikophen AC 1000 by Evonik, Dowsil 3037, Dowsil 3074, Dowsil 5314, and KR-510 by Shin-Etsu.

Based on experimental data, exemplary tackifying resins may include the following:

| Resin | |
|---|---|
| Kraton Sylvares TP96 | terpene phenolic resin |
| Si Group SP134 | Terpene formaldehyde phenol resin |
| Neville Cumar 130 | low molecular weight, hydrocarbon |
| | resin produced predominantly with |
| | indene and other aromatic monomers |
| | (coumarone indene) |
| Neville Cumar 105 | low molecular weight, hydrocarbon |
| | resin produced predominantly with |
| | indene and other aromatic monomers |
| | (coumarone indene) |
| Neville Cumar P25 | low molecular weight liquid resin |
| | (coumarone indene) |
| Techrez D95 | gum rosin |
| Euro Yser YT103 | gum rosin |
| TECHrez R98 | gum rosin ester |
| Rosin ester 5105 | gum rosin ester |

Based on the experimental data, exemplary plasticizers may include the following plasticizers:

| Plasticizer | |
|---|---|
| plasthall 190 | Aliphatic alkylated ester |
| Mythl Soyate 1000 | |
| Poly-G 20-37 | Polyether diol #1 |
| Poly-G 20-58 | Polyether diol #2 |
| DINCH | Diisononyl Phthalate |
| poly G 20-265 | Polyether diol #3 |

Based on the experimental data, catalysts may include the following catalysts:

| Catalyst-activator | |
|---|---|
| DAMO-T | Diamino functional silane(n-2-aminoethyl-3- |
| | aminopropyltrimethoxysilane) |
| GF 91 | Diamino functional silane |
| TIB KAT 25 | Tin catalyst |
| DBU | 1,8-diazabicyclo [5.4.0]undéc-7-ène |

It is further contemplated that the adhesive composition may include a desiccant, such as vinyltrimethoxysilane (VTMO).

In one embodiment, the polymer may be a blend of silylated polymer with silicone resin intermediate. One example of the polymer which may be a blend of silylated polymer with silicone resin intermediate may be polymer XT manufactured by WACKER, such as WACKER XT 50 or WACKER XT 55.

Additionally, the polymer may include WACKER XT 50 or WACKER XT 55 and a reactive diluant such as XM 20 or XM 25.

In an embodiment, the tackifying resin may include gum rosin, and may be a combination of gum rosin and coumarone indene, or a combination of gum rosin and a terpene phenolic resin. In another embodiment, tackifying resin may be a combination of gum rosin, coumarone indene, and a terpene phenolic resin. In one example, gum rosin may be Techrez D95. In one example, coumarone indene may be Neville Cumar 130 resin. In one example, terpene phenolic resin (also referred as terpene phenol) may be SYLVARES TP96.

Advantageously, the adhesive composition of the present disclosure that includes the tackifying resin may have at least a 5 pounds per linear inch peel strength on substrates which include rubber such as thermoplastic polyolefin (TPO) and plastic such as polyvinyl chloride (PVC). It is contemplated that the peel strength may be a 180-degree peel about 5 pounds per linear inch (PLI) on each of PVC and TPO. In an embodiment of the disclosure, it is contemplated that a ratio of the tackifying resin to polymer may be at least 0.05 to 2.5.

In another embodiment of the disclosure, the adhesive composition may further include a solvent. In one example, the solvent may be methyl acetate. In other examples, the solvent may be acetone, methyl ethyl ketone (MEK), or ethyl acetate.

One of the advantages of the adhesive composition is the ability to be employed with a canister. The liquid adhesive composition may be propellant compatible, to temperatures as low as −10 degrees Celsius.

It is contemplated that the adhesive composition may be formed through a tackifying resin master batch. A resin master batch may be a blend of solid or liquid with a plasticizer. If the resin used is solid, a blend is heated above the resin melting point in order speed up the dissolution of the resin. It is contemplated that the resin master batches are stable and not recrystallizing. The viscosity of the blend may range from liquid at room temperature to high viscous liquid at room temperature.

The tackifying resin master batch may be formed by dissolving the selected resin in a selected plasticizer in a high shear double jacket vacuum vessel. The plasticizer may be heated to 80-100° Celsius in order to accelerate the dissolution of the resin. The resin may be slowly added into the hot plasticizer. The temperature may be maintained until the resin is completely dissolved. If fillers are used in the adhesive composition, the fillers may be slowly added after complete dissolution of the resin. A vacuum may be applied in order to remove moisture from the master batch-filler mixture. The moisture content of the master batch may be controlled with and Karl Fischer titration.

It is contemplated that when the temperature of the mixture reaches 60° Celsius, the vacuum may be removed and a desiccant, such as VTMO, may be added under slight mixing condition. In general, the quantity of VTMO added may be equal to 1 to 3% of a final adhesive composition by weight.

It is then contemplated that a quantity of silylated polymer may be added under shear in order to mix the silylated polymer with the tackifying resin master batch.

After a storage phase, the composition may be cooled to 25° C. and an accelerator, catalyst, and stabilizer such as Anti UV and antioxidant may be added under nitrogen atmosphere. Antioxidants that may be employed if desired may include hindered phenols and phosphate esters. These materials may be employed in amounts up to about 5% by weight based on the total weight of the adhesive composition.

The adhesive composition of the present disclosure may be used to bond two substrates. The liquid adhesive composition may be applied to one substrate by roller, spatula, or sprayed. The adhesive composition may be wet at application and may start to cure when exposed to atmospheric humidity. After 5 to 15 minutes depending on environment conditions such as temperature & humidity, the two substrates may be bonded and joined. A slight pressure may be applied on the two substrates in order to eliminate any air entrapped between the two substrates.

Experimental Testing Results

In a first test, 182 grams of WACKER XT 50, (a blend of silylated polymer with silicone resin intermediate) was combined with 17 grams of SYLVARES TP96 70/30 in plasthall 190 (a terpene phenol), 17 grams CUMAR 130 70/30 in plasthall 190 (coumarone indene), and 8 grams of TECHREZ D95 70/30 in plasthall 190 (a gum rosin) along with 4 grams of vinyltrimethoxysilane (a dessicant) and 3 grams of DAMO-T (a catalyst activator). This presented a tackifying resin/polymer ratio of 0.14. At a 48-hour peel strength test, the adhesive composition was greater than 10 PLI on both PVC and TPO. However, in a second test, 182.4 grams of WACKER XT 50, (a blend of silylated polymer with silicone resin intermediate) was combined with 4 grams of vinyltrimethoxysilane (a dessicant) and 2 grams of DAMO-T (a catalyst activator). In the second test, no tackifying resin was added to the adhesive composition. At a 7-day peel strength test, the adhesive composition was less than 2 PLI on both PVC and TPO.

In a third test, 182.4 grams of WACKER XT 50, (a blend of silylated polymer with silicone resin intermediate) was combined with 15.2 grams of TECHREZ D95 130 50/50 n plasthall 190 (a gum rosin) along with 4 grams of vinyltrimethoxysilane (a dessicant) and 1 gram of DAMO-T (a catalyst activator). This presented a tackifying resin/polymer ratio of 0.05. At a 48-hour peel strength test, the adhesive composition was greater than 6 PLI on PVC and greater than 10 PLI on TPO.

In a fourth test, 140 grams of WACKER XT 50, (a blend of silylated polymer with silicone resin intermediate) was combined with 34 grams of SYLVARES TP96 60/40 in Poly-G 20-37 (a terpene phenol), 34 grams of CUMAR P25 60/40 in Poly-G 20-37 (coumarone indene), and 16 grams of TECHREZ D95 60/40 in Poly-G 20-37 (a gum rosin) along with 4 grams of vinyltrimethoxysilane (a dessicant), 1 gram of DAMO-T (a catalyst activator) and 35 grams of Ultra-Plfex. This presented a tackifying resin/polymer ratio of 0.36. At a 7-day peel strength test, the adhesive composition was greater than 6 PLI on PVC and greater than 10 PLI on TPO.

In a fifth test, 140 grams of WACKER XT 50, (a blend of silylated polymer with silicone resin intermediate) was combined with 68 grams of CUMAR 130 60/40 in Poly-G 20-37 (coumarone indene), and 21.6 grams of TECHREZ D95 60/40 in Poly-G 20-37 (a gum rosin) along with 1 gram of vinyltrimethoxysilane (a dessicant), and 3 grams of TIB KAT 25/white spirit 50/50 (a catalyst). This presented a tackifying resin/polymer ratio of 0.38. At a 7-day peel strength test, the adhesive composition was greater than 6 PLI on PVC and greater than 6 PLI on TPO.

In a sixth test, 90 grams of WACKER XT 50, (a blend of silylated polymer with silicone resin intermediate), and 50 grams of WACKER XT 55, (a blend of silylated polymer with silicone resin intermediate) was combined with 40 grams of Sylvares TP96 60/40 in Poly-G 20-37 (a terpene phenol), 40 grams of Cumar 130 60/40 poly G 20-37/myth soyat 50/50 (coumarone indene), and 20 grams of Techrez D95 60/40 in Poly-G 20-58 (a gum rosin) along with 4 grams of vinyltrimethoxysilane (a dessicant), and 2 grams of Wacker GF 91 (an adhesion promoter) and 80 grams of ULTRA-PHLEX. ULTRA-PHLEX may be a precipitated calcium carbonate with a narrow particle size distribution by Specialty Minerals, Inc. This presented a tackifying resin/polymer ratio of 0.43. At a 7-day peel strength test, the adhesive composition was greater than 6 PLI on PVC and greater than 6 PLI on TPO.

In a seventh test, 120 grams of WACKER XT 50, (a blend of silylated polymer with silicone resin intermediate), and 20 grams of WACKER XM20 was combined with 34 grams of Sylvares TP96 60/40 in Mythl Soyate 1000 (a terpene phenol), 34 grams of Cumar 130 60/40 in Mythl Soyate 1000 (coumarone indene), and 16 grams of Techrez D95 60/40 in Mythl Soyate 1000 (a gum rosin) along with 1 gram of vinyltrimethoxysilane (a dessicant), and 3 grams of Wacker GF 91 (an adhesion promoter). This presented a tackifying resin/polymer ratio of 0.36. At a 7-day peel strength test, the adhesive composition was greater than 5 PLI on PVC and greater than 5 PLI on TPO.

In an eighth test, 50 grams of RISUN 30000T (a silylated polymer) and 10 grams of Dowsil 3074 (a silicone resin intermediate) was combined with 78 grams of Sylvares TP96 (a terpene phenol), 10 grams of Techrez 95 (a gum rosin), 15 grams of Kristalex 3100 (a hydrocarbon resin), and 65 grams of methyl acetate pre treated with 3% PTSI (a solvent) along with 0.9 grams of vinyltrimethoxysilane (a dessicant), 6 grams of DAMO-T (a catalyst), and 0.75 grams of TIB KAT 226 (a catalyst). This presented a tackifying resin/polymer ratio of 1.5. The silylated polymer to silicone resin intermediate ratio is 5. At a 24-hour peel strength test, the adhesive composition was greater than 6 PLI on PVC and greater than 6 PLI on TPO.

In a ninth test, 50 grams of RISUN 30000T (a silylated polymer) and 10 grams of KR-510 by Shin-Etsu (a silicone resin intermediate) was combined with 78 grams of Sylvares TP96 (a terpene phenol), 10 grams of Techrez 95 (a gum rosin), 15 grams of Kristalex 3100 (a hydrocarbon resin), and 65 grams of methyl acetate pre treated with 3% PTSI (a solvent) along with 0.9 grams of vinyltrimethoxysilane (a dessicant), 6 grams of DAMO-T (a catalyst), and 0.75 grams of TIB KAT 226 (a catalyst). This presented a tackifying resin/polymer ratio of 1.5. The silylated polymer to silicone resin intermediate ratio is 5. At a 24-hour peel strength test, the adhesive composition was greater than 6 PLI on PVC and greater than 6 PLI on TPO.

In a tenth test, 86 grams of RISUN 30000T (a silylated polymer) and 35 grams of Dowsil 3037 (a silicone resin intermediate) was combined with 84 grams of Techrez 95 (a gum rosin) along with 1 gram of vinyltrimethoxysilane (a dessicant), 6 grams of Dynasylan 1124 (an adhesion promoter), and 1 gram of TIB KAT 226 (a catalyst). This presented a tackifying resin/polymer ratio of 0.7. The silylated polymer to silicone resin intermediate ratio is 2.5. At a 3-day peel strength test, the adhesive composition was greater than 5 PLI on PVC and greater than 5 PLI on TPO.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. An adhesive composition, comprising:
a polymer, the polymer is a blend of a silylated polymer with silicone resin intermediate; and
a tackifying resin, the tackifying resin includes gum rosin, wherein the adhesive composition has a peel strength of a 180-degree peel of at least 5 pounds per linear inch (PLI) on each of rubber and plastic.

2. The adhesive composition of claim 1, wherein a tackifying resin to polymer ratio in weight is at least 0.05 to 2.5.

3. The adhesive composition of claim 1, further comprising a solvent.

4. The adhesive composition of claim 3, wherein the solvent is methyl acetate.

5. The adhesive composition of claim 3, wherein the solvent is acetone.

6. The adhesive composition as claimed in claim 1, wherein the tackifying resin further includes coumarone indene.

7. The adhesive composition as claimed in claim 1, wherein the tackifying resin further includes terpene phenol.

8. The adhesive composition as claimed in claim 1, wherein the polymer is at least one of WACKER XT 50 or WACKER XT 55.

9. An adhesive composition, comprising:
a polymer, the polymer is a blend of a silylated polymer with silicone resin intermediate;
a tackifying resin, the tackifying resin includes gum rosin; and
a solvent, wherein the adhesive composition has a peel strength of a 180-degree peel of at least 5 pounds per linear inch (PLI) on each of rubber and plastic.

10. The adhesive composition of claim 9, wherein a tackifying resin to polymer ratio in weight is at least 0.05 to 2.5.

11. The adhesive composition of claim 9, wherein the solvent is methyl acetate.

12. The adhesive composition of claim 9, wherein the solvent is acetone.

13. The adhesive composition as claimed in claim 9, wherein the tackifying resin further includes coumarone indene.

14. The adhesive composition as claimed in claim 9, wherein the tackifying resin further includes terpene phenol.

15. The adhesive composition as claimed in claim 9, wherein the polymer is at least one of WACKER XT 50 or WACKER XT 55.

16. The adhesive composition as claimed in claim 9, wherein the silylated polymer is RISUN 30000T.
